(19) United States
(12) Patent Application Publication
(10) Pub. No.: US 2008/0108027 A1
(43) Pub. Date: May 8, 2008

(54) GRAPHICAL RADIALLY-EXTENDING FAMILY HEDGE

(76) Inventor: MATTHEW D. SALLIN, New York, NY (US)

Correspondence Address: JONATHAN P. KUDLA, 35 GLENDALE, # 6, SAN FRANCISCO, CA, 94114, US

(21) Appl. No.: 11/551,700

(22) Filed: Oct. 20, 2006

(51) Int. Cl. G09B 19/00

(52) U.S. Cl. 434/154

(57) ABSTRACT

An exemplary embodiment provides for a graphical radially-extending family hedge. The family hedge displays a user's ancestors, contemporaneous generation and next generation. Additionally, the family hedge displays the user's spousal and in-law information. Both blood and in-law relations expand out from the user to N degrees of separation. When a member of the family hedge other than the user is selected, the family hedge re-arranges itself such that it expands out to N degrees of separation from the selected member.

### BACKGROUND

Internet-based genealogy research is one of the most popular uses of the world-wide web. An interest to discover where one comes, and who they are connected to from drives this leveraging of modern-day information technologies. Client-based genealogy software is also a popular tool to organize a genealogy enthusiast's familial information.

Typical prior art genealogical research or client-based applications usually will result in some form of a family tree. One example of a typical prior art family tree 100 is shown in FIG. 1. The family tree 100 is more or less “centered” on a genealogy enthusiast that will be referred to as ego 102 and further includes the ego's 102 mother 104 and father 106. The term “ego” is used to indicate the person whom the family tree 100 is generally focused upon and/or the person who entered information which generated the family tree 100. The family tree 100 further includes the ego's 102 maternal grandparents (108, 110) and maternal great grandparents (112, 114, 116, 118). In a similar manner, the family tree also includes the ego's 102 paternal grandparents (120, 122) and paternal grandparents (124, 126, 128, 130).

One quality of family tree 100 is that it is primarily “vertical” which is further demonstrated via FIG. 2 which depicts a vertical representation 200 of the family tree 100 of FIG. 1. As indicated by the vertical representation 200, the family tree 100 is focused on previous generations in relation to the ego 102. While the family tree 100 can effectively give the ego 102 a clear indication of their ancestors, it is lacking in a number of respects. For example, family tree 100 will typically require a considerable amount of research to be performed by the ego 102. The results of that research are then entered by the ego 102 in order to generate the family tree 100. Other deficiencies of the family tree 100 include not providing any method, system or interface to view siblings and in-law relations. Additionally, the family tree 100 will also typically lack any method, system or interface to expand beyond the vertical representation 200.

In view of the foregoing, it may be useful to provide methods and systems that facilitate an improved family tree that does not suffer from the aforementioned prior art deficiencies.

The foregoing examples of the related art and limitations related therewith are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

The claimed embodiments provide for a graphical radially-extending family hedge. The family hedge displays a users ancestors, contemporaneous generation and next generation. Additionally, the family hedge displays the user's spousal and in-law information. Both blood and in-law relations expand out from the user to N degrees of separation. When a member of the family hedge other than the user is selected, the family hedge re-arranges itself such that it expands out to N degrees of separation from the newly selected member.

One embodiment by way of non-limiting example provides for a computer-implemented method for generating a graphical radially-extending genealogy hedge that includes collecting familial information from a user and producing the graphical radially-extending genealogy hedge based on the collected familial information such that the graphical radially-extending genealogy hedge radially extends from the user out to N degrees of separation. Links extending from the user to immediate family members represent a first degree of separation away from the user and each successive link extending beyond individuals of the immediate family members represents an additional degree of separation away from the user.

Another embodiment by way of non-limiting example includes computer-implemented method for generating a graphical radially-extending genealogy hedge that includes collecting familial information from a user and matching individual members of the collected familial information with individual members of previously collected familial information from other users. The graphical radially-extending genealogy hedge is then produced based on the collected familial information such that the graphical radially-extending genealogy hedge radially extends from the user out to N degrees of separation. Links extending from the user to immediate family members represent a first degree of separation away from the user and each successive link extending beyond the individuals of the immediate family members represents an additional degree of separation away from the user.

In addition to the exemplary aspects and embodiments described above, further aspects and embodiments will become apparent by reference to the drawings and by study of the following descriptions.

### BRIEF DESCRIPTION OF THE DRAWINGS

Exemplary embodiments are illustrated in referenced figures of the drawings. It is intended that the embodiments and figures disclosed herein are to be considered illustrative rather than limiting.

FIG. 1 illustrates a prior art family tree;

FIG. 2 is a representation of an aspect of the family tree of FIG. 1;

FIG. 3 is a representation of an aspect of a family hedge, in accordance with an exemplary embodiment;

FIG. 4 illustrates a family hedge, in accordance with an exemplary embodiment;

FIGS. 5-13 illustrate a series of family hedge transitions when a new ego is selected, in accordance with an exemplary embodiment;

FIG. 14 is a block diagram of an embodiment of a network, such as the Internet;

FIG. 15 is a block diagram of an embodiment of a computer that can be used as a client computer system or a server computer system or as a web server system;

FIG. 16 illustrates an implementation of the family hedge that includes mini-nodes, in accordance with an exemplary embodiment;

FIGS. 17-18 illustrate a series of family hedge transitions involving selection of a divorced spouse, in accordance with an exemplary embodiment; and

FIG. 19 is a flowchart illustrating a method for generating a family hedge, in accordance with an exemplary embodiment.

### DETAILED DESCRIPTION

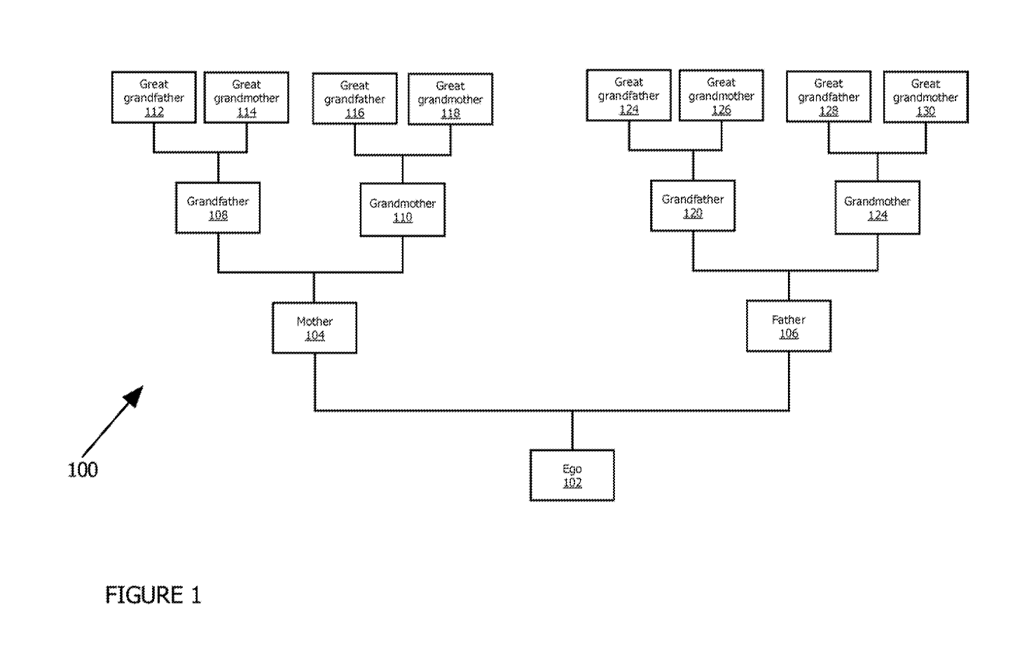

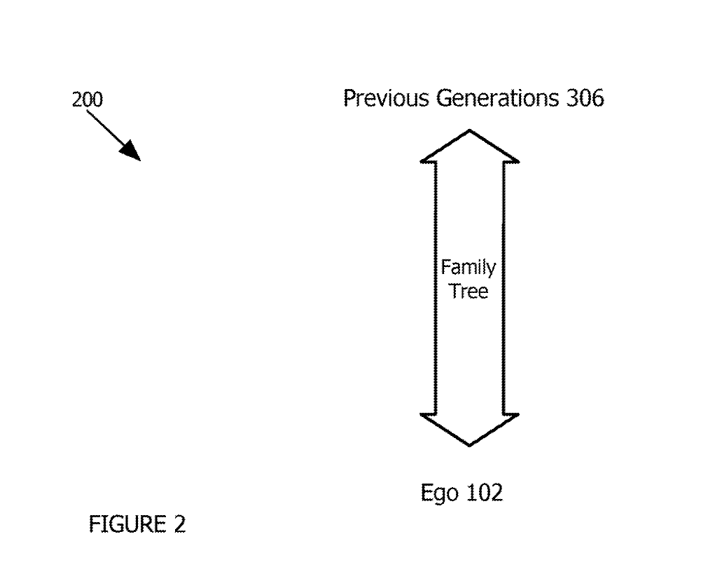

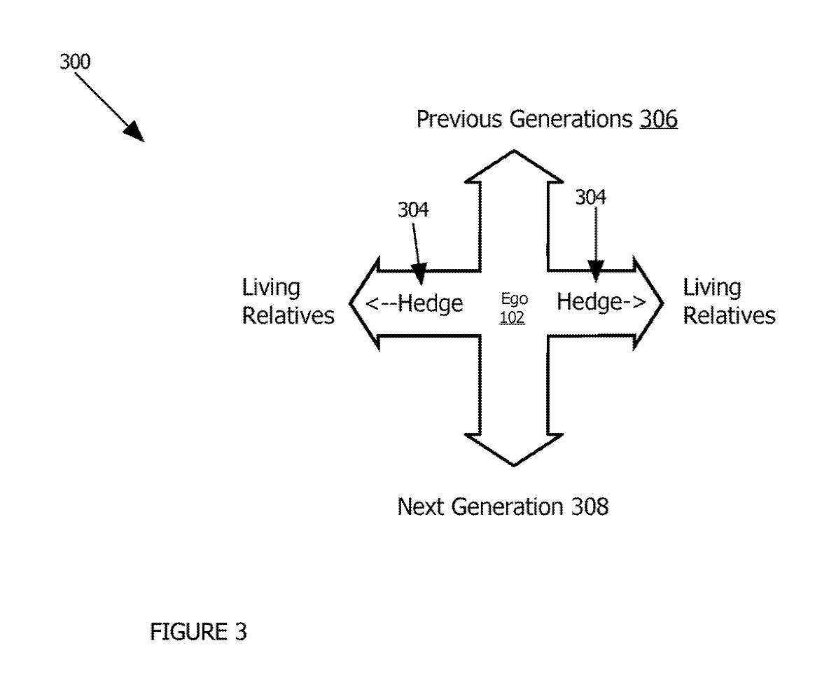

Aspects of the claimed embodiments contemplate methods and systems for implementing a “family hedge.” The family hedge differs from prior art family trees in that the family hedge includes contemporaneous generation information, next generation information, spouse information and extended in-law relations. As a result the family hedge expands out radially and is not limited by bloodline which is characteristic of prior art family trees. The radial/hedge characteristic of the claimed embodiments is further visualized via FIG. 3 which is a representation 300 of an aspect of a family hedge, in accordance with the claimed embodiments. Similar to representation 200, representation 300 is focused on a user/genealogy enthusiast/ego 102. However, representation 300 differs from representation 200 in one particular aspect in that an ego 102, of FIG. 3, is centered whereas the ego 102, of FIG. 1, is at the bottom of family tree representation 200.

Speaking on the “hedge” aspect of the claimed embodiments, a hedge in a typical sense typically refers to a row of closely planted shrubs or low-growing trees forming a fence or boundary. In the spirit of that typical definition, representation 300 includes “hedges” 304 which depict an ego's current generation/living relatives, ancestors and descendents. However, it should be appreciated that the term “hedge” is merely descriptive of aspects of the claimed embodiments. The family hedge, of the claimed embodiments, radially extends from the ego and is not strictly limited to a horizontal dimension such as a hedge. Representation 300 can also include previous generations 306 as well as the next generation 308, if applicable.

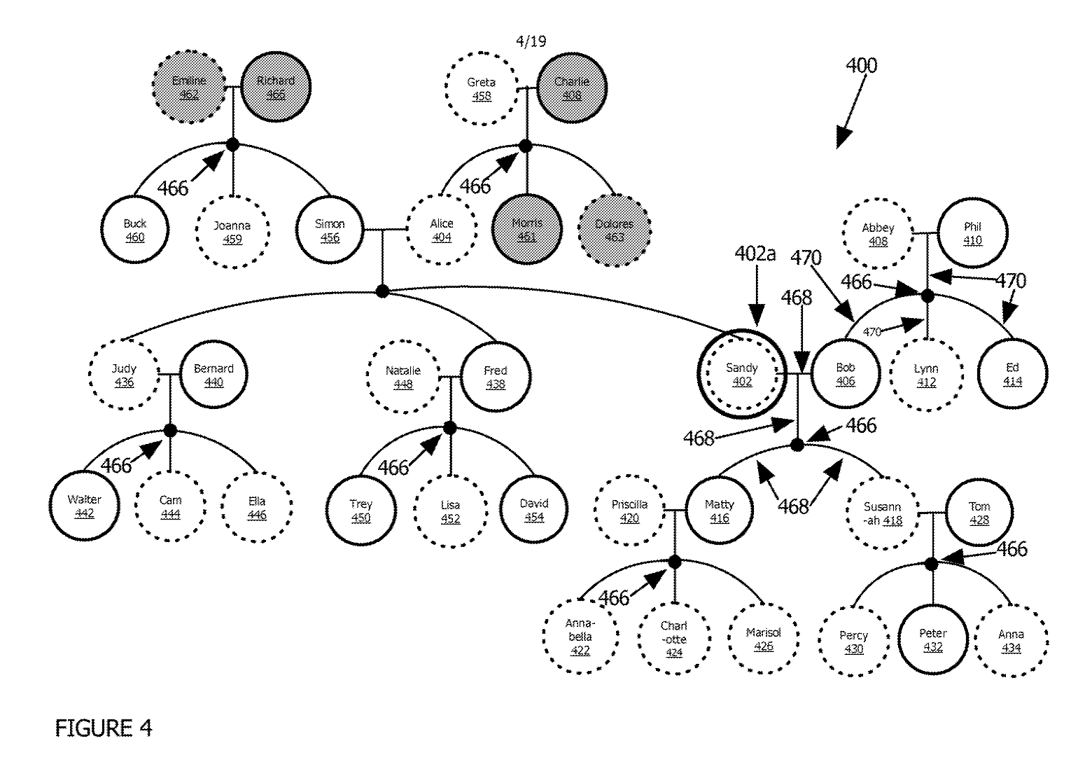

To more fully describe the claimed embodiments, FIG. 4 will now be described which illustrates a family hedge 400, in accordance with the claimed embodiments. Family hedge 400 is based on collected familial information from a number of sources that will be described in later sections. A currently selected ego for the family hedge 400 is Sandy 402. This is indicated via extra outer circle 402a. The ego can be indicated through a variety of graphical indicators such as a bolded-circle, cross-hatching, a patterned circle boundary, etc. The claimed embodiments are not meant to be limited via the selected conventions, such as how to distinguish the ego, of the various figures. Furthermore, there are other graphical conventions that can be employed by the family hedge 400 and they are also not meant to limit the claimed embodiments in any particular manner. These other conventions include, but are not limited to, using a dashed circle boundary to indicate a female member of family hedge 400, using a solid circle boundary to indicate a male member of family hedge 400 and using a shaded circle to indicate a deceased member of family hedge 400. As can be seen via family hedge 400, examples include Sandy 402—a female, her husband Bob 406 (male) and Sandy's maternal grandfather Charlie 408 (deceased). Additionally, segment points 466 indicate a union, blood, step or otherwise, to indicate a person's children.

In addition to Sandy 402, Bob 404 and Charlie 408, family tree 400 also includes several other family members. Those other family members include Sandy's parents in-law Abbey 408 and Phil 410, Sandy's sister in-law Lynn 412 and brother in-law Ed 414. Sandy's children are Matty 416 and Susannah 418. Matty 416 is married to Priscilla 420 and their children include Annabella 422, Charlotte 424 and Marisol 426. Susannah 418 is married to Tom 428 and their children include Percy 430, Peter 432 and Anna 434.

Sandy 402 has a sister Judy 436 and a brother Fred 438. In turn, Judy 436 is married to Bernard 440 and their children are Walter 442, Cam 444 and Ella 446. Fred has a wife Natalie 448 and their children include Trey 450, Lisa 452 and David 454.

Sandy's parents are Alice 404 and Simon 456. Alice's 404 parents are Charlie 408 and Greta 458. Alice's siblings are Morris 461 and Dolores 463. Simon's 456 siblings include Joanna 459 and Buck 460 and Simon's parents are Emiline 462 and Richard 464.

One aspect of the family tree 400 is that it expands out from the ego, in this case Sandy 402, out to N degrees of separation. In the embodiment depicted in FIG. 4, N is 2 degrees of separation. For example, Sandy's 402 husband Bob 406, their children (Matty 416, Susannah 418), Sandy's siblings (Judy 436, Fred 433) and Sandy's parents (Simon 456, Alice 404) are all 1 degree of separation from Sandy 402. All other family members displayed in family hedge 400, of FIG. 4, are 2 degrees of separation from Sandy 402. In one embodiment, one degree of separation is represented by one link, such as link 468, from ego/Sandy 402. Two degrees is represented, in one embodiment, by a second link not connected to ego/Sandy 402 such as link 470. As indicated in FIG. 4, links 468 and 470 represent paths between two individual members of family hedge 400. As such, links 468 and 470 can take multiple paths but only represent one degree of separation between any two contiguously-linked members of family hedge 400.

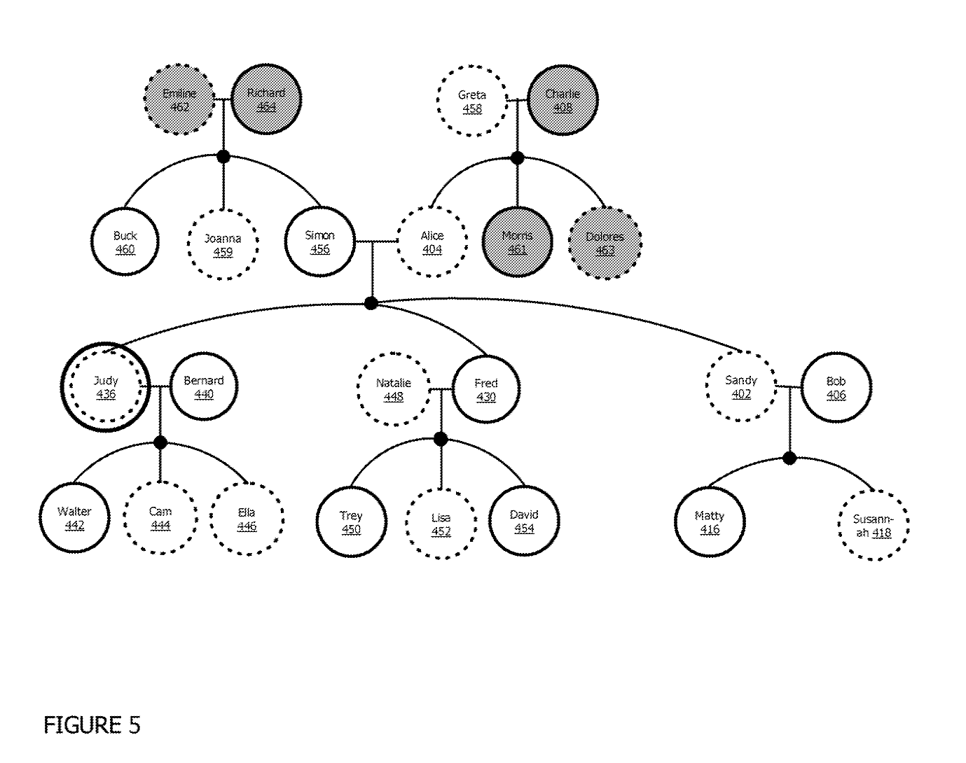

In one embodiment, family hedge 400 is re-arranged when another member of the family hedge 400, other than the ego, is selected. This is further described via FIGS. 5-13 which illustrate a series of family hedge transitions when a new ego is selected, in accordance with the claimed embodiments. In FIG. 5, Judy 436 is selected to be the new ego. As a result, any family members depicted in FIG. 4 that are not two degrees of separation away from Judy 436 will no longer be displayed. Specifically, Sandy's 402 extended family is removed and that includes Sandy's in-laws (Lynn 412, Ed, 414, Abbey 408, Phil 410, Priscilla 420, Tom 428) and grandchildren (Annabella 422, Charlotte 424, Marisol 426, Percy 430, Peter 432, Anna 434).

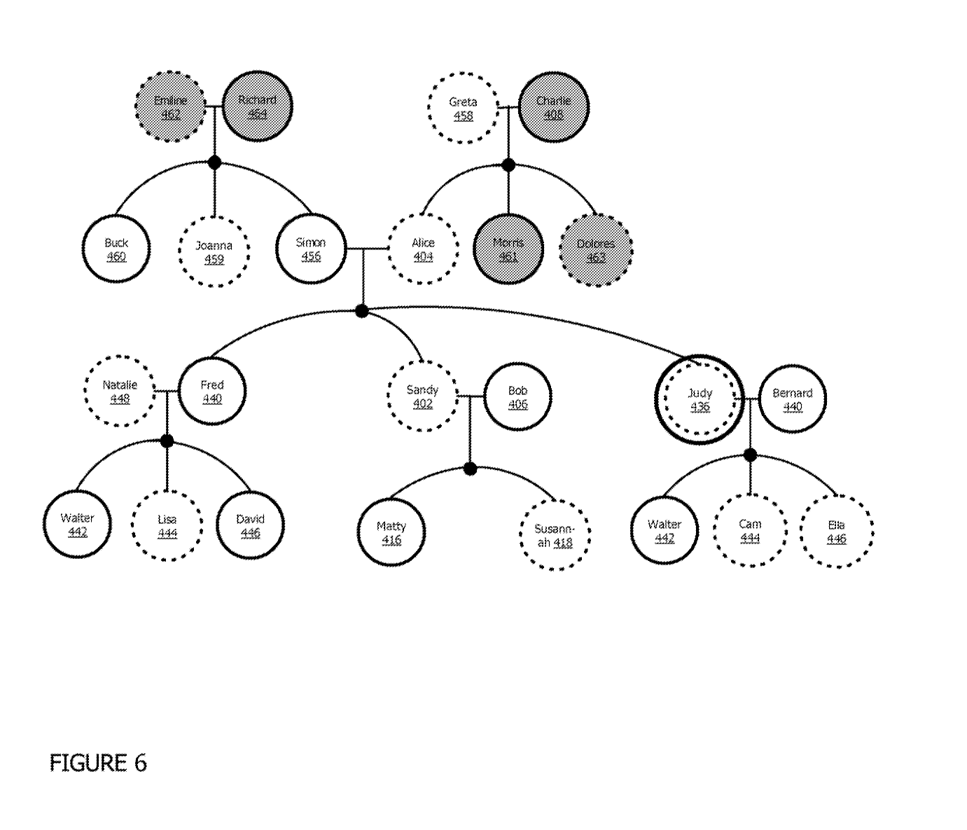

To accommodate members of the family hedge that are two degrees away from the newly selected ego Judy 436 and whom will eventually be displayed, Judy's 436 nuclear family (Bernard 440, Walter 442, Cam 444, Ella 446) swings over to the right, as shown in FIG. 6. Also, Sandy's 402 nuclear family (Bob 406, Matty 416, Susannah 418) and Fred's 440 nuclear family (Natalie 448, Walter 442, Lisa 444, David 446) moves over to the left.

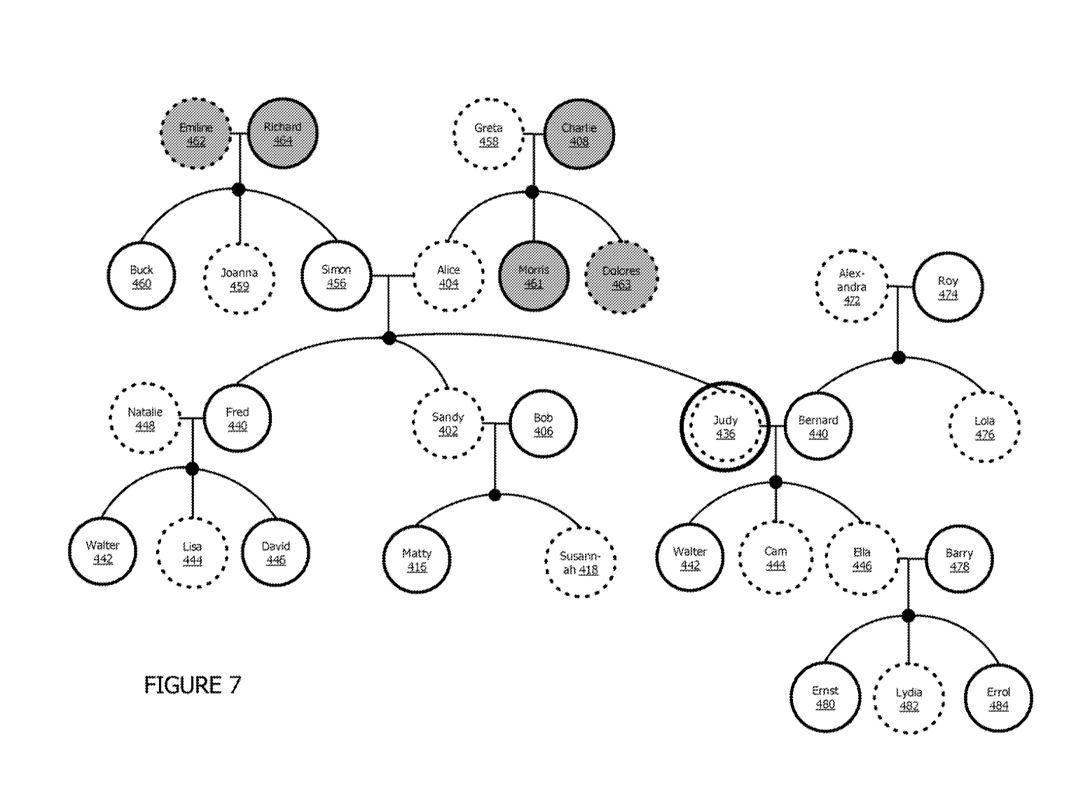

After the re-arrangement of FIG. 6, members of the family hedge that are two degrees away from Judy, that were not previously displayed, folds out. This is shown in FIG. 7. Specifically, Judy's 436 in-laws (Alexandra 472, Roy 474, Lola 476, Barry 478) and grandchildren (Ernst 480, Lydia 482, Errol 484) are now displayed.

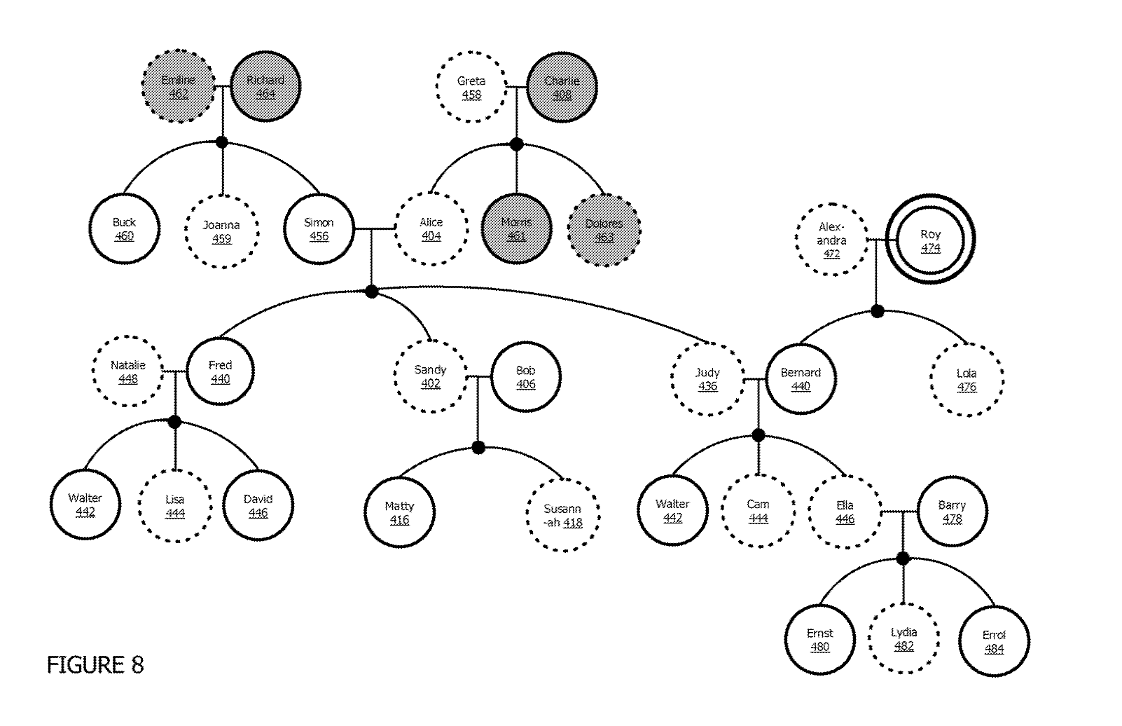

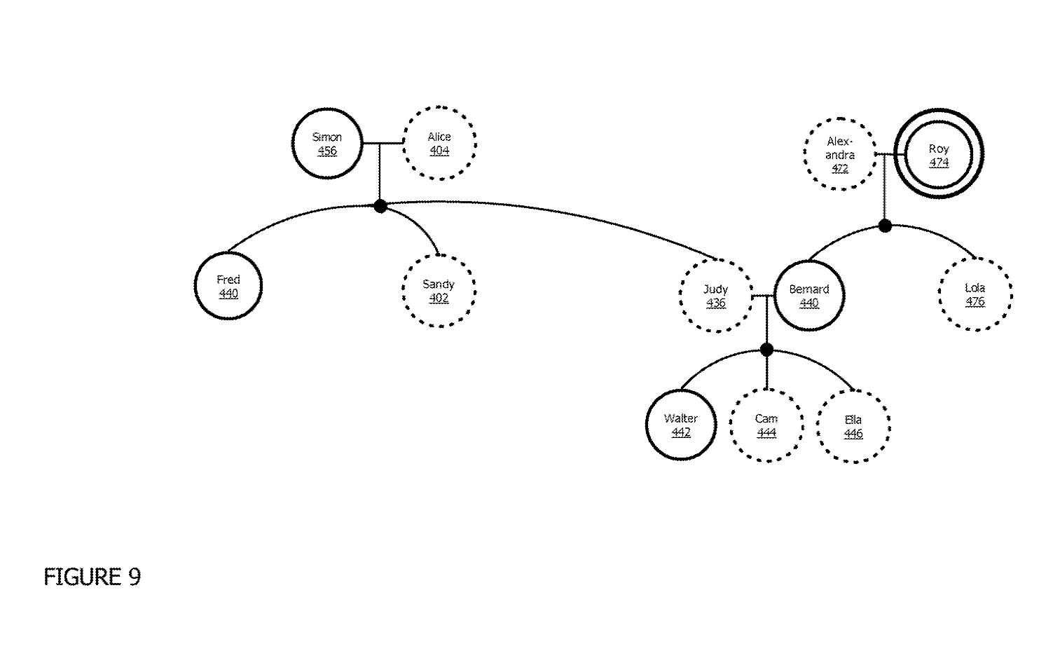

Next, yet another ego Roy 474 is selected as shown in FIG. 8. As a result the family hedge transitions as is shown starting in FIG. 9 wherein family members more than one degree away Judy 436 are removed. Specifically, Natalie 448, Walter 442, Lisa 444, David 446, Matty 416, Susannah 418, Emiline 462, Richard 464, Greta 458, Charlie 408, Buck 460, Joanna 459, Morris 461, Bob 406 and Dolores 463 are removed from the family tree. The claimed embodiments are not meant to be limited via the transition from FIG. 8 to FIG. 9 and other transitions. Each transition is merely exemplary.

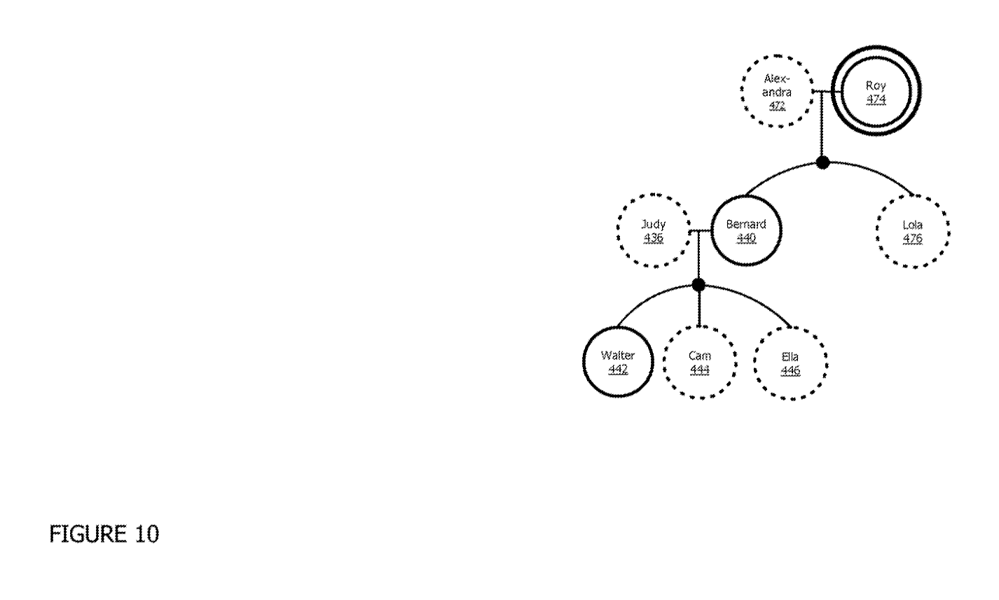

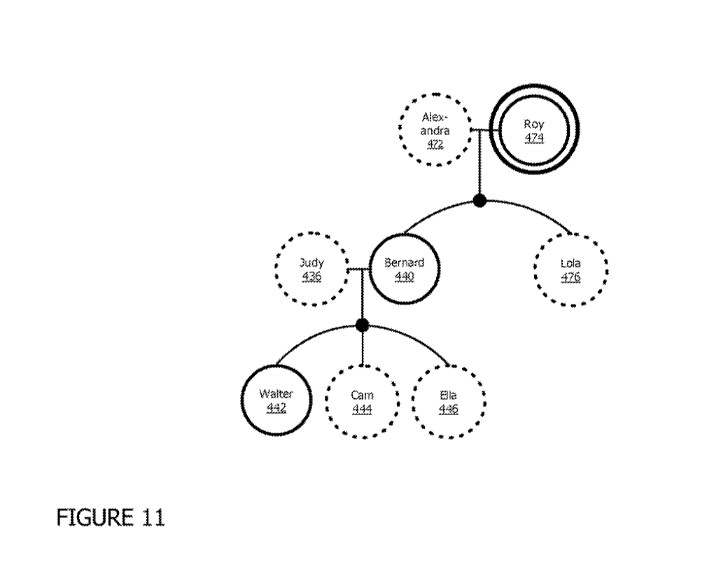

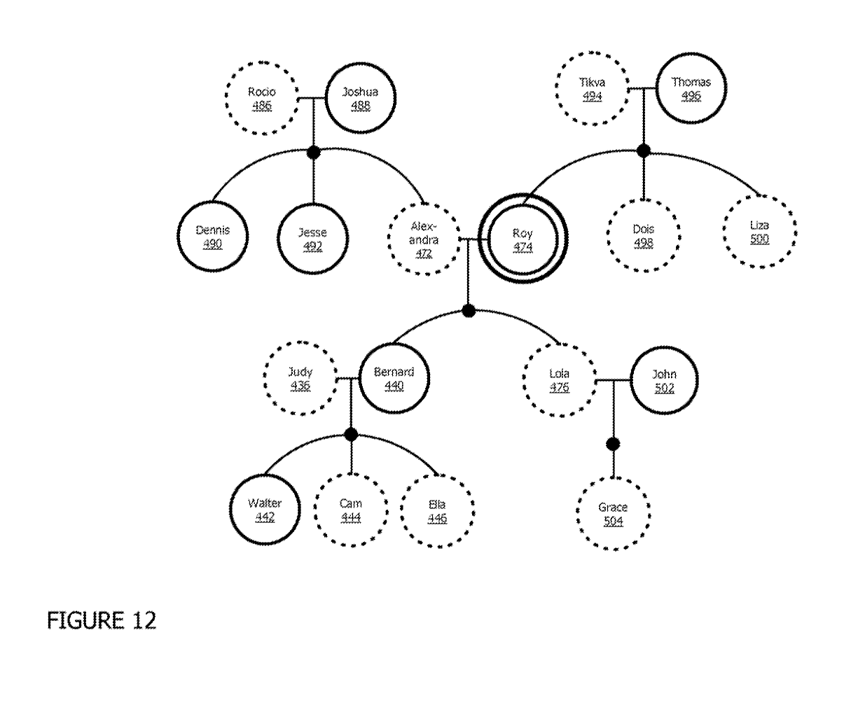

Next, in FIG. 10, Judy's 436 parents (Simon 456, Alice 404) and siblings (Fred 440, Sandy 402) disappear. In FIG. 11, the family hedge moves over to the right and down one generation level to accommodate members of the family hedge that are two degrees of separation from Roy 474. Next, in FIG. 12, Roy's in-laws (Rocio 486, Joshua 488, Dennis 490, Jesse 492, John 502) fold out as well as Roy's parents (Tikva 494, Thomas 496), siblings (Dois 498, Liza 500) and an additional grandchild Grace 504.

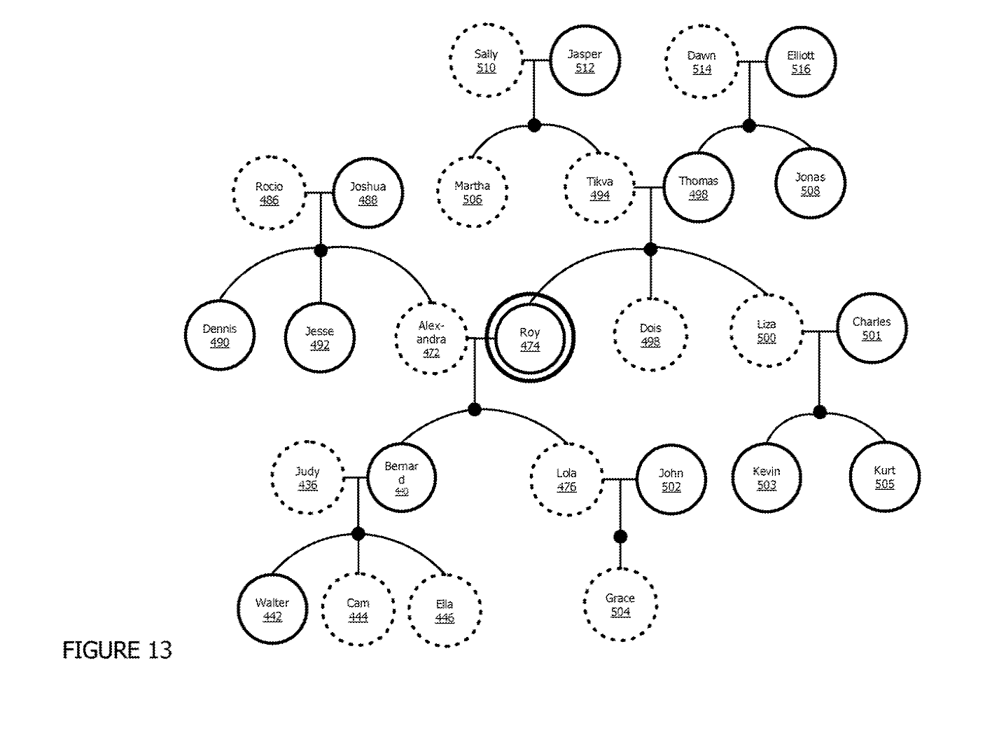

In FIG. 13, all members of the family hedge that are two degrees of separation from Roy 474 are folded out. The additional members include Roy's Aunt Martha 506, Roy's Uncle Jonas 508, Roy's grandparents (Sally 516, Jasper 512, Dawn 514 and Elliott 516), Roy's brother-in-law Charles (501) and nephews (Kevin 503 and Kurt 505).

In one embodiment, the transitions described in FIGS. 4-13 will generally fold out in a smooth fashion while or before or after various other members/nodes disappear to accommodate a newly-selected ego and members that are two degrees of separation from that newly selected ego. However, the claimed embodiments are not limited to such a graphical transition and other types of graphical transitions can be utilized.

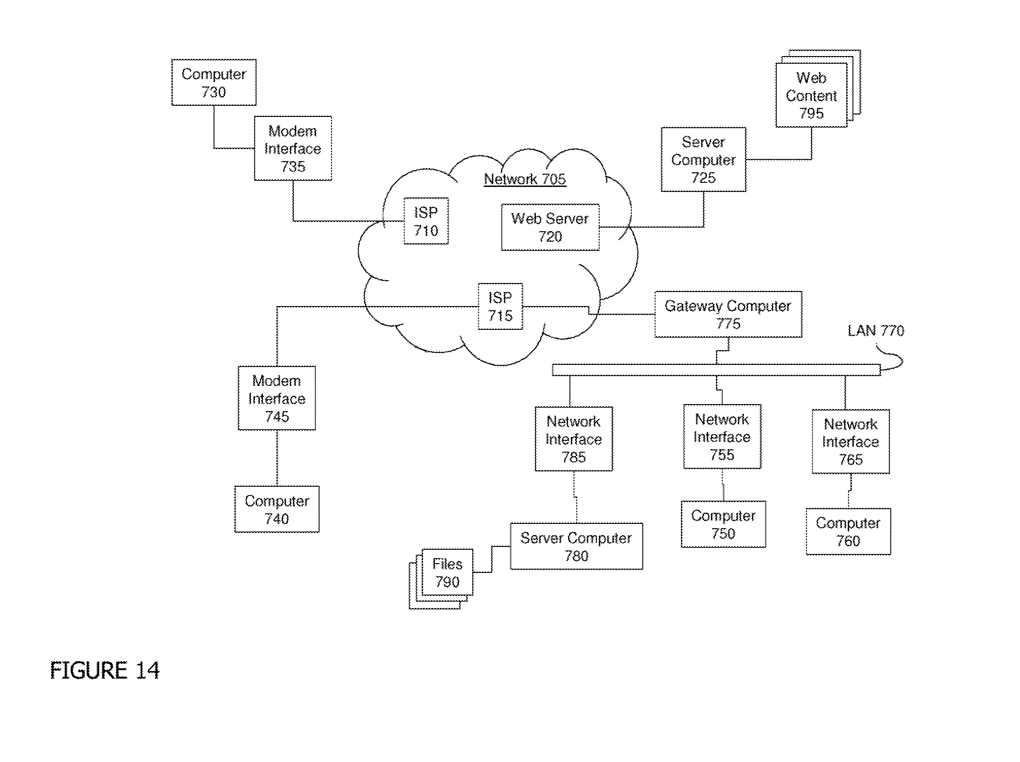

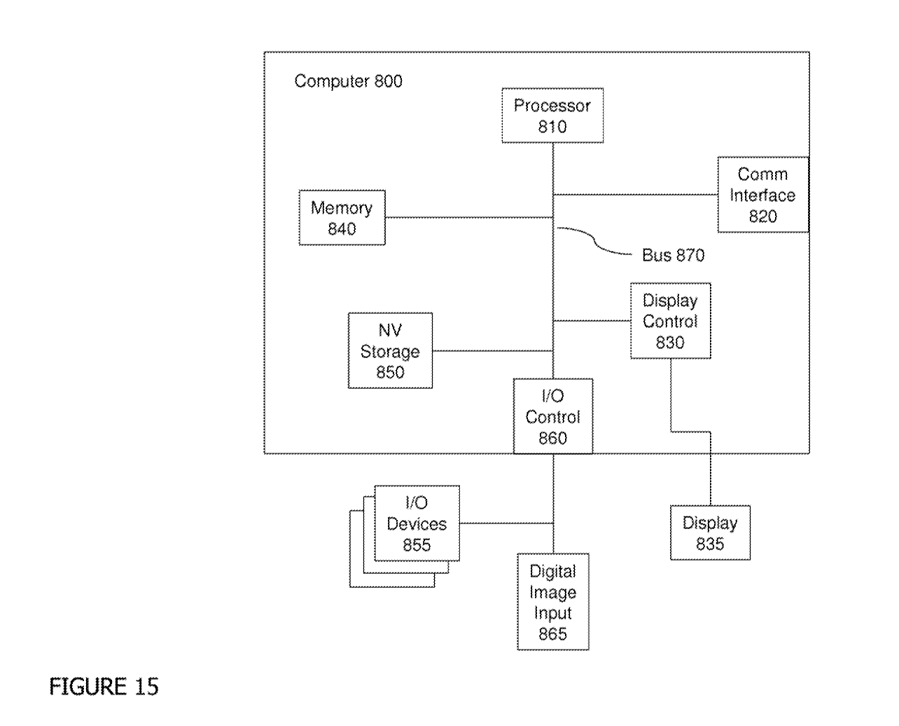

The following description of FIGS. 14-15 is intended to provide an overview of computer hardware and other operating components suitable for performing the methods of the claimed embodiments, but is not intended to limit the applicable environments. Similarly, the computer hardware and other operating components may be suitable as part of the apparatuses of the claimed embodiments. The claimed embodiments can be practiced with other computer system configurations, including hand-held devices, multiprocessor systems, microprocessor-based or programmable consumer electronics, network PCs, minicomputers, mainframe computers, and digital audio receivers that may receive digital radio broadcasts from a satellite and the like. The claimed embodiments can also be practiced in distributed computing environments where tasks are performed by remote processing devices that are linked through a communications network.

FIG. 14 is a block diagram of an exemplary embodiment of a network 705, such as the Internet. The term “Internet” as used herein refers to a network of networks which uses certain protocols, such as the TCP/IP protocol, and possibly other protocols such as the hypertext transfer protocol (HTTP) for hypertext markup language (HTML) documents that make up the World Wide Web (web). The physical connections of the Internet and the protocols and communication procedures of the Internet are well known to those of skill in the art.

Access to the Internet 705 is typically provided by Internet service providers (ISP), such as the ISPs 710 and 715. Users on client systems, such as client computer systems 730, 740, 750, and 760 obtain access to the Internet through the Internet service providers, such as ISPs 710 and 715. Access to the Internet allows users of the client computer systems to exchange information, receive and send emails, and view documents, such as documents which have been prepared in the HTML format. These documents are often provided by web servers, such as web server 720 which is considered to be “on” the Internet. Often these web servers are provided by the ISPs, such as ISP 710, although a computer system can be set up and connected to the Internet without that system also being an ISP.

The web server 720 is typically at least one computer system which operates as a server computer system and is configured to operate with the protocols of the World Wide Web and is coupled to the Internet. Optionally, the web server 720 can be part of an ISP which provides access to the Internet for client systems. The web server 720 is shown coupled to the server computer system 725 which itself is coupled to web content 795, which can be considered a form of a media database. While two computer systems 720 and 725 are shown in FIG. 14, the web server system 720 and the server computer system 725 can be one computer system having different software components providing the web server functionality and the server functionality provided by the server computer system 725 which will be described further below.

Client computer systems 730, 740, 750, and 760 can each, with the appropriate web browsing software, view HTML pages provided by the web server 720. The ISP 710 provides Internet connectivity to the client computer system 730 through the modem interface 735 which can be considered par of the client computer system 730. The client computer system can be a personal computer system, a network computer, a Web TV system, or other such computer system.

Similarly, the ISP 715 provides Internet connectivity for client systems 740, 750, and 760, although as shown in FIG. 14, the connections are not the same for these three computer systems. Client computer system 740 is coupled through a modem interface 745 while client computer systems 750 and 760 are part of a LAN. While FIG. 14 shows the interfaces 735 and 745 as generically as a “modem,” each of these interfaces can be an analog modem, ISDN modem, cable modem, satellite transmission interface (e.g. “Direct PC”), or other interfaces for coupling a computer system to other computer systems.

Client computer systems 750 and 760 may be coupled to a LAN 770 through network interfaces 755 and 765, which can be Ethernet network or other network interfaces. The LAN 770 is also coupled to a gateway computer system 775 which can provide firewall and other Internet related services for the local area network. This gateway computer system 775 is coupled to the ISP 715 to provide Internet connectivity to the client computer systems 750 and 760. The gateway computer system 775 can be a conventional server computer system. Also, the web server system 720 can be a conventional server computer system.

Alternatively, a server computer system 780 can be directly coupled to the LAN 770 through a network interface 785 to provide files 790 and other services to the clients 750, 760, without the need to connect to the Internet through the gateway system 775.

FIG. 15 is a block diagram of an exemplary embodiment of a computer that can be used as a client computer system or a server computer system or as a web server system. Such a computer system can be used to perform many of the functions of an Internet service provider, such as ISP 710. The computer system 800 interfaces to external systems through the modem or network interface 820. It will be appreciated that the modem or network interface 820 can be considered to be part of the computer system 800. This interface 820 can be an analog modem, ISDN modem, cable modem, token ring interface, satellite transmission interface (e.g. “Direct PC”), or other interfaces for coupling a computer system to other computer systems.

The computer system 800 includes a processor 810, which can be a conventional microprocessor such as an Intel Pentium microprocessor or Motorola Power PC microprocessor. Memory 840 is coupled to the processor 810 by a bus 870. Memory 840 can be dynamic random access memory (DRAM) and can also include static RAM (SRAM). The bus 870 couples the processor 810 to the memory 840, also to non-volatile storage 850, to display controller 830, and to the input/output (I/O) controller 860.

The display controller 830 controls in the conventional manner a display on a display device 835 which can be a cathode ray tube (CRT), liquid crystal display (LCD), plasma screens, LED screens and other displays. The input/output devices 855 can include a keyboard, disk drives, printers, a scanner, and other input and output devices, including a mouse or other pointing device. The display controller 830 and the I/O controller 860 can be implemented with conventional well known technology. A digital image input device 865 can be a digital camera which is coupled to an I/O controller 860 in order to allow images from the digital camera to be input into the computer system 800.

The non-volatile storage 850 is often a magnetic hard disk, an optical disk, or another form of storage for large amounts of data. Some of this data is often written, by a direct memory access process, into memory 840 during execution of software in the computer system 800. One of skill in the art will immediately recognize that the terms “machine-readable medium” or “computer-readable medium” includes any type of storage device that is accessible by the processor 810 and also encompasses a carrier wave that encodes a data signal.

The computer system 800 is one example of many possible computer systems which have different architectures. For example, personal computers based on an Intel microprocessor often have multiple buses, one of which can be an input/output (I/O) bus for the peripherals and one that directly connects the processor 810 and the memory 840 (often referred to as a memory bus). The buses are connected together through bridge components that perform any necessary translation due to differing bus protocols.

Network computers are another type of computer system that can be used with the claimed embodiments. Network computers do not usually include a hard disk or other mass storage, and the executable programs are loaded from a network connection into the memory 840 for execution by the processor 810. A Web TV system, which is known in the art, is also considered to be a computer system according to this embodiment, but it may lack some of the features shown in FIG. 14, such as certain input or output devices. A typical computer system will usually include at least a processor, memory, and a bus coupling the memory to the processor.

In addition, the computer system 800 is controlled by operating system software which includes a file management system, such as a disk operating system, which is part of the operating system software. One example of an operating system software with its associated file management system software is the family of operating systems known as Windows® from Microsoft Corporation of Redmond, Wash., and their associated file management systems. Another example of an operating system software with its associated file management system software is the LINUX operating system and its associated file management system. The file management system is typically stored in the non-volatile storage 850 and causes the processor 810 to execute the various acts required by the operating system to input and output data and to store data in memory, including storing files on the non-volatile storage 850.

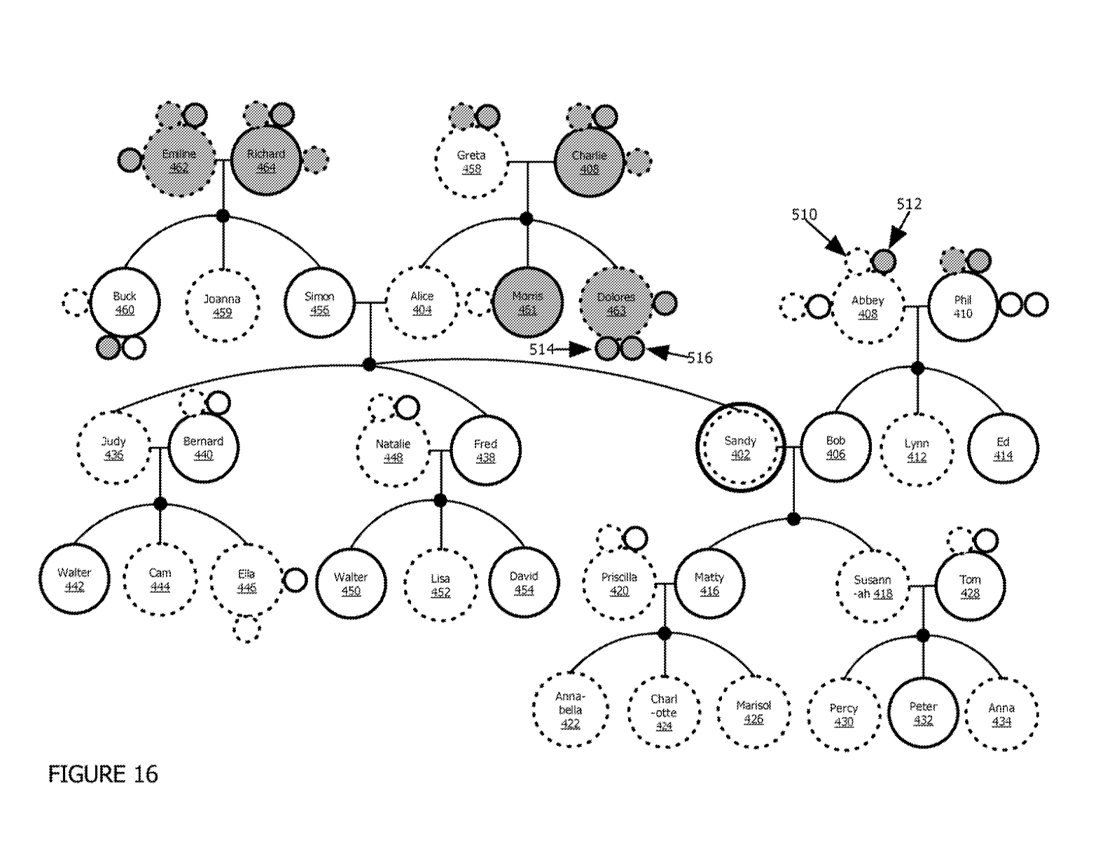

Another aspect of the claimed embodiments envisions “mini-nodes.” Mini-nodes provide convenient access to a third degree of separation from a currently-selected ego while a family hedge, such as the family hedge displayed in FIGS. 4-13, primarily displays two degrees of separation from the currently-selected ego. This is further displayed via FIG. 16 which illustrates an implementation of the family hedge that includes mini-nodes, in accordance with an exemplary embodiment. An example of mini-nodes includes Abbey's 408 parents (510, 512). Abbey's parents are three degrees of separation from the currently-selected ego 402 Sandy 402. Similarly, Sandy's Aunt Dolores' children (514, 516) are also three degrees of separation from Sandy 402. As can been from FIG. 16, there are various other mini-nodes that can be selected that are 3 degrees of separation from Sandy 402. When one of the mini-nodes is selected, the family tree will typically re-arrange itself based on the newly selected ego out to 2 degrees of separation.

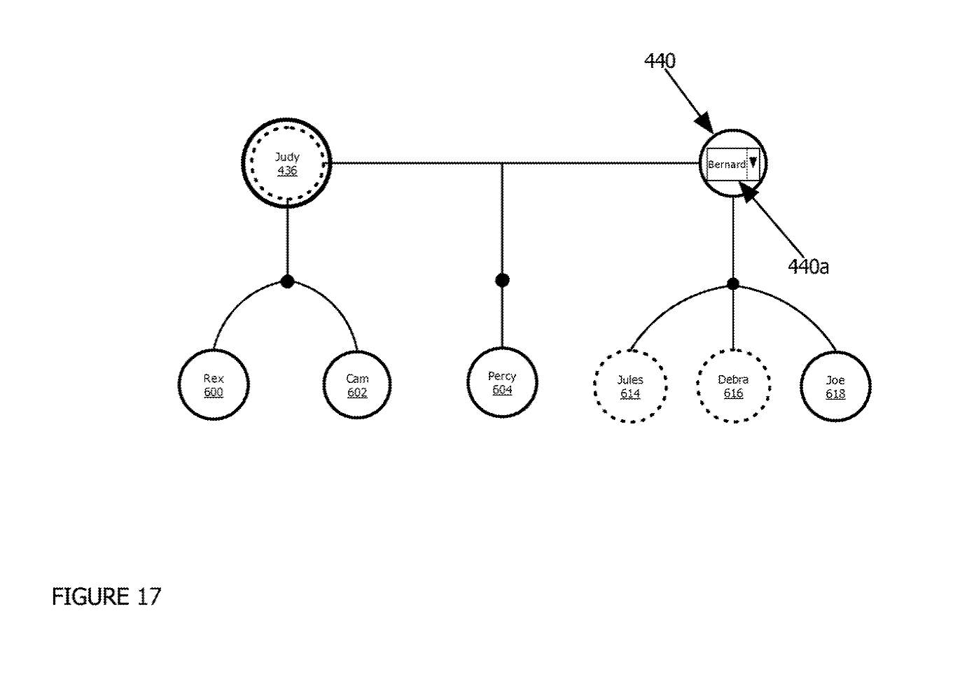

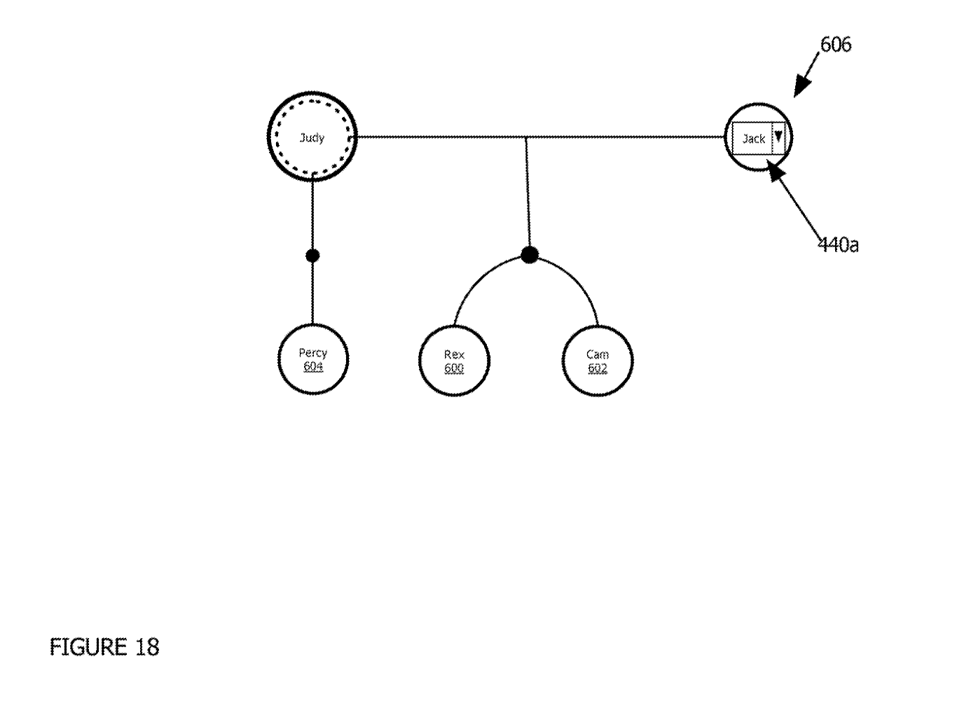

The family hedge also provides for divorced spousal information and step children. These aspects are illustrated via FIGS. 17-18 which shows a series of family hedge transitions involving selection of a divorced spouse and any involved step-children, in accordance with an exemplary embodiment. It should be noted that FIGS. 4-13 and 16 do not overlap even though some names and reference numerals may be repeated. Re-stated, FIGS. 17-18 describe aspects of the claimed embodiments that may or may not overlap with the previous figures.

FIG. 17 includes Judy 436 and her relations to Bernard 440. As can be seen Bernard is currently selected via a drop-down menu 440a. A result of Bernard's 440 relations with Judy 436 is their child Percy 604. Also displayed in FIG. 17 are Judy's children from a previous marriage (Rex 600, Cam 602) and Bernard's 440 children from a previous marriage (Jules 614, Debra 616 and Joe 618).

Next, via FIG. 18, a previous spouse of Judy 436 is selected via drop-down box 440a—Jack 606. As a result, of the new selection Judy's 436 and Jack's children (Rex 500, Cam 602) are displayed and Percy 604 is moved to the left as he is not a child of Jack.

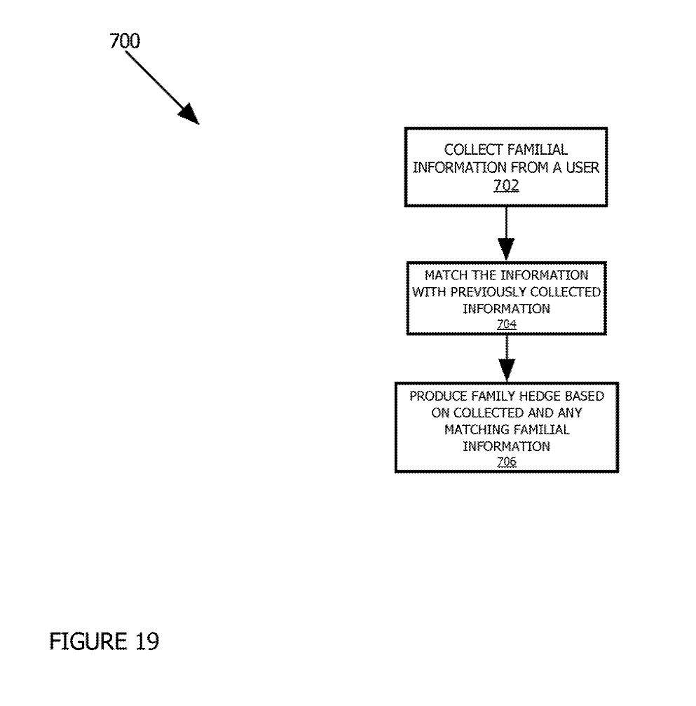

Now that various exemplary embodiments of the family hedge has been described, a method 700 for generating the family hedge will now be described via FIG. 19. Method 700 can be performed by a computer 800 either as a client-based software package or over a web interface contained on computer 800 that is connected to a network such as network 705 that is in turn connected to a remote server. Initially, familial information will be collected from an ego 102 at operation 702. Collecting familial information includes determining if certain types of familial information are available and then collecting that information if it is in fact available. An example would be determining if sibling information is available and then collecting the sibling information if it is available. Other familial information can include, but not limited to, family relationship-type, names, hometown, residency, occupation, hobbies/interests, schools and companies.

Next, at operation 704, the collected familial information is matched up with previously collected familial information. The previously collected familial information could have been collected from other egos, the ego currently entering the information or via a “GEDCOM” input file format. GEDCOM, an acronym for GEnealogical Data COMmunication, is a specification for exchanging genealogical data between different genealogical systems. It was developed by The Church of Jesus Christ of Latter-day Saints as an aid in their genealogical research. A GEDCOM file is typically plain text, such as ASCII, containing genealogical information about individuals, and data linking these records together. Generally, genealogy software supports importing from and/or exporting to GEDCOM format.

Regarding the claimed embodiments, it should be noted that the term “user” is utilized as a person entering familial information. Furthermore, “user” is a relative term depending upon one's vantage point. For example, if a person is entering familial information, they are an ego from their viewpoint but they would otherwise be viewed as a user as observed by a third party. Due to this, the claimed embodiments can perhaps be referring to either a “user” or an “ego.”

The matching operation 704 allows for the family hedge to be continually extending and not static to just one person/ego. For example, an ego may enter their familial information and a member of the ego's family contained in that information may match up as the same person entered by another ego. As a result individual family hedges can be linked together. Once the family information is collected, the family hedge is produced via operation 70. It should be noted that the matching operation 704 can be an optional operation.

As described in the preceding sections, the claimed embodiments advantageously provide for a family hedge that radially extends out from a currently-selected ego. As a result, an ego, or other user, can easily ascertain familial relations for both blood and in-law relationships that are not limited to previous ancestors. Additionally, another ego can be selected and the family hedge re-arranges itself out to two degrees of separation.

In one implementation of the family hedge, a Wiki-model is employed wherein multiple users are allowed to enter and edit familial information in order to generate, maintain and expand the family hedge. Additionally, relationships between family members can be editable.

In another implementation, email addresses of each family member are collected and an email message is sent to the family members inviting them to enter additional familial information to expand the family hedge.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

1. A computer-implemented method for generating a graphical radially-extending genealogy hedge comprising:
collecting familial information from a user;
producing the graphical radially-extending genealogy hedge based on the collected familial information such that the graphical radially-extending genealogy hedge radially extends from the user out to N degrees of separation;
wherein links extending from the user to immediate family members represent a first degree of separation away from the user; and
wherein each successive link extending beyond individuals of the immediate family members represents an additional degree of separation away from the user.

2. The method as recited in claim 1 wherein the collected familial information from the user is from an electronic file.

3. The method as recited as recited in claim 2 wherein the format of the electronic file is a GEDCOM file format.

4. The computer-implemented method as recited in claim 1 wherein N is 2.

5. The computer-implemented method as recited in claim 4 wherein the familial information includes both blood and in-law relationships.

6. The computer-implemented method as recited in claim 5 wherein collecting familial information further comprises:
determining if sibling information is available;
collecting the sibling information from the user, if the sibling information is available;
determining if parent information is available;
collecting the parent information from the user, if the parent information is available;
determining if grandparent information is available;
collecting the grandparent information from the user, if the grandparent information is available;
determining if aunt information is available;
collecting the aunt information if the aunt information is available;
determining if uncle information is available;
collecting the uncle information if the aunt information is available;
determining if child information is available;
collecting the child information from the user, if the child information is available;
determining if niece/nephew information is available;
collecting the niece/nephew information from the user, if the niece/nephew information is available;
determining if grandchild information is available;
collecting the grandchild information from the user, if the grandchild information is available;
determining if in-law information is available; and
collecting the in-law information from the user, if the in-law information is available.

7. The computer-implemented method as recited in claim 6 wherein collecting in-law information further comprises:
determining if in-law sibling information is available;
collecting the in-law sibling information, if the in-law sibling information is available;
determining if in-law parent information is available; and
collecting the in-law parent information, if the in-law parent information is available.

8. The computer-implemented method as recited in claim 1 wherein the method further comprises:
selecting a member of the graphical radially-extending family hedge other than the user; and
re-arranging the graphical radially-extending family hedge to extend from the selected member out to N degrees of separation.

9. The computer-implemented method as recited in claim 4 wherein the method further comprises:
selecting a member of the radially-extending family hedge other than the user; and
re-arranging the graphical radially-extending family hedge to extend from the selected member out to N degrees of separation.

10. The computer-implemented method as recited in claim 1 wherein deceased relatives of the user are distinguished from living relatives.

11. The computer-implemented method as recited in claim 4 wherein individual members of the collected familial information are graphically represented as nodes and wherein the graphical radially-extending genealogy hedge further includes at least one mini-node adjacent to an individual member of the collected familial information wherein the at least one mini-node represents N+1 degrees of separation from the user.

12. The computer-implemented method as recited in claim 4 wherein the graphical radially-extending family hedge further includes a drop-down menu that allows for selection of a current spouse of a user and one or more previous spouses of the user.

13. The computer-implemented method as recited in claim 11 wherein additional familial information can be added via other users, related to the user, via a Wiki-model.

14. The computer-implemented method as recited in claim 1 wherein collecting familial information further comprises:
choosing a family relationship-type for a particular member of the user's family;
collecting a name of the particular member;
collecting hometown information of the particular member;
collecting current residency information of the particular member;
collecting occupation information of the particular member; and
collecting hobby/interest information of the particular member.

15. The computer-implemented method as recited in claim 14 further comprising:
collecting email information of the particular member; and
sending an email invitation to the particular member to add additional familial information.

16. The method as recited in claim 15 wherein the email contains a representation of the graphical radially-extending family hedge.

17. A computer-implemented method for generating a graphical radially-extending genealogy hedge comprising:
collecting familial information from a user;
matching individual members of the collected familial information with individual members of previously collected familial information from other users;
producing the graphical radially-extending genealogy hedge based on the collected familial information and any matching individual members of the previously collected familial information such that the graphical radially-extending genealogy hedge radially extends from the user out to N degrees of separation;
wherein the radially-extending genealogy hedge includes family members of the matched individual members not specified by the user;
wherein links extending from the user to immediate family members represent a first degree of separation away from the user; and
wherein each successive link extending beyond individuals of the immediate family members represents an additional degree of separation away from the user.

18. The computer-implemented method as recited in claim 17 wherein N is 2.

19. The computer-implemented method as recited in claim 18 wherein the familial information includes both blood and in-law relationships.

20. A system operable to generate a graphical radially-extending genealogy hedge comprising:
a network interface;
one or more processors;
a memory; and
an application, stored in the memory, including instructions operable to cause the one or more processors and the network interface to:
collect familial information from a user;
match individual members of the collected familial information with individual members of previously collected familial information from other users;
produce the graphical radially-extending genealogy hedge based on the collected familial information and any matching individual members of the previously collected familial information such that the graphical radially-extending genealogy hedge radially extends from the user out to N degrees of separation;
wherein links extending from the user to immediate family members represent a first degree of separation away from the user; and
wherein each successive link extending beyond individuals of the immediate family members represents an additional degree of separation away from the user.
